(19) United States
(12) Patent Application Publication
(10) Pub. No.: US 2002/0188629 A1
(43) Pub. Date: Dec. 12, 2002

(54) System, protocol, and methods for the creation of distributed spreadsheets

(76) Inventor: Daniel C. Burfoot, New London, CT (US)

Correspondence Address: Daniel C. Burfoot, 65 Chapel Drive, New London, CT, 06320, US

(21) Appl. No.: 09/973,654

(22) Filed: Oct. 10, 2001

Related U.S. Application Data
(60) Provisional application No. 60/292,263, filed on May 21, 2001.
(60) Provisional application No. 60/292,264, filed on May 21, 2001.

(51) Int. Cl. G06F 17/00

(52) U.S. Cl. 707/503; 707/536

(57) ABSTRACT

The present invention describes a suite of methods, protocols, and software systems that allow for the creation of distributed spreadsheets. Distributed spreadsheets are spreadsheets that contain cell references to external data, in particular data that is located somewhere on the internet. This enables users to incorporate external data into their spreadsheets without having to go back and update them when the external data changes.

### BACKGROUND OF THE INVENTION

The present invention relates generally to the field of computer science, and, more particularly, to the field of distributed computing and electronic spreadsheets. Anyone who is familiar with web applications, object-oriented programming, and spreadsheet applications should have sufficient knowledge to evaluate the present invention.

Spreadsheet applications are very common and powerful computer programs that contain numerical data, such as corporate finances, and allow users to easily make calculations based on that data. Before spreadsheets, these sorts of tasks were done by hand and were therefore very time-consuming and error-prone.

The paradigm of computing which was dominant as spreadsheets became popular was that of desktop computing, where there is one user, using one machine, editing one file. The recent trend in computer science has been towards distributed applications. A distributed application typically is used by many people, uses data drawn from a variety of files or databases, and runs on many machines.

Most spreadsheet applications, such as Microsoft Excel, allow users to refer in one spreadsheet to data in another spreadsheet within the same file. This allows users to group related information into a set of spreadsheets often called a ‘workbook’. This feature is useful because it allows data to be normalized, meaning that one piece of data exists in exactly one place, as opposed to being replicated whenever it is needed. Consider an accountant calculating a firm's yearly profit by adding together the monthly profit information, which are kept in separate spreadsheets. If he were not able to make references, he would have to copy the data from the monthly reports into the yearly spreadsheet, and if the data from the monthly reports changed, he would have to make changes in the yearly report as well. With the use of references, this problem goes away.

Most spreadsheet applications typically also allow the user to import data from outside sources such as the web or an external database. However, these operations are not rigorous or standardized and the information sources are usually not designed to serve spreadsheet data. One example of this is Microsoft Excel's “web query” feature, which downloads an HTML page, attempts to find a table, and enters the contents of this table into the spreadsheet. This feature, while occasionally useful, is limited in is applicability.

Users of spreadsheets often find themselves incorporating data from outside sources into their spreadsheets. For example, they might contain references to a company's stock price or interest rates. However, if the information they use changes, they often find themselves in the position of having to go back into their spreadsheets and change the information by hand. This is tedious and error-prone.

Moreover, there are many applications, usually custom-built, in existence today that process and aggregate numerical data, such as point of sale or billing applications. These applications range in functionality and usability, but all would benefit by having a standard system allowing users to access the information accumulated by these programs in desktop spreadsheets.

Therefore, the present state of the art would benefit by the creation of a structure which enables the integration of these applications, allowing data collected and created by many different users and companies to be shared between them all.

### BRIEF SUMMARY OF INVENTION

The present invention describes various methods, protocols, and software systems useful for the creation of distributed spreadsheets. Distributed spreadsheets are spreadsheets which contain references to data that exists external to the file, machine, or application that the spreadsheet is running on, in particular, data that is resident on a server across the internet. This technique allows users to minimize the amount of time spent updating their spreadsheets with new or changed data and to make sure that their spreadsheets always contain the most up-to-date information.

For example, imagine a user who wishes to create a spreadsheet describing various aspects of her financial position, which includes information from stock prices, bank accounts, and real estate. Each of these components fluctuates constantly. Therefore, instead of looking up these values and inserting them into her spreadsheet by hand, the user makes references in the spreadsheet to locations where this data is stored.

The spreadsheet application, Microsoft Excel for example, is programmed to resolve these references by looking for data across the internet. This is done by sending a query to the machine, called a DSS server, which hosts the data. The DSS server responds with the desired information and the spreadsheet application inserts it into the spreadsheet cell. The user now has a spreadsheet presenting a view of her financial position, and because the application periodically refreshes the data from the DSS server, the view is always up-to-date.

Furthermore, users can publish their spreadsheets to DSS servers, making their calculations and data available to other people. For example, an analyst with an investment bank might use analytical techniques to create a spreadsheet representing his estimate of the earnings potential and value of a particular company. This spreadsheet could involve data drawn from various sources like the stock market, interest and inflation statistics from the Federal Reserve, currency exchanges, and sales and profit numbers from the company itself He could then place his spreadsheet on a DSS server and make his analysis open to the public, or to a certain groups of people. They in turn could create and publish their own sets of spreadsheets using his data, creating an interlocking network of shared information.

Companies can integrate their spreadsheets with their corporate information systems. For example, imagine a company with a point of sale (POS) application that they use to track sales of their product. While the application is highly efficient at collecting and managing sales data, it is not designed for graphical or numerical analysis. By integrating the system with a DSS server, users can view and analyze the POS application's data in advanced spreadsheet applications. They can also share the information with other groups of people who might be interested.

FIG. 2 illustrates an assortment of people and programs using distributed spreadsheets to share data.

The present invention describes various aspects of the operation of a distributed spreadsheet system, including the DSS server which hosts and serves data, and the DSS protocol (DSSP) which provides a framework for DSS communication.

### DESCRIPTION OF DRAWINGS

FIG. 1: this diagram illustrates the 3-tier framework of the DSS server. The lower three components, “web server”, “business logic”, and “persistence layer”, compose the DSS server, while the “web browser” and “client application” are external programs that interact with the DSS server.

FIG. 2: this diagram is an illustration of several persons and software programs working together using distributed spreadsheets. There are three DSS servers in the center of the drawing. The one in the upper left serves a large company, allowing it to aggregate and analyze data from all of the disparate software applications that the company uses. One such application is in the upper right corner. The DSS server for an investment bank allows the analyst there to use the data published by the company in his analyses of the company's revenue potential and profitability. Finally, the DSS server for the online bank allows its user(s) to analyze her financial portfolio, taking into account data from the large company and from the investment bank.

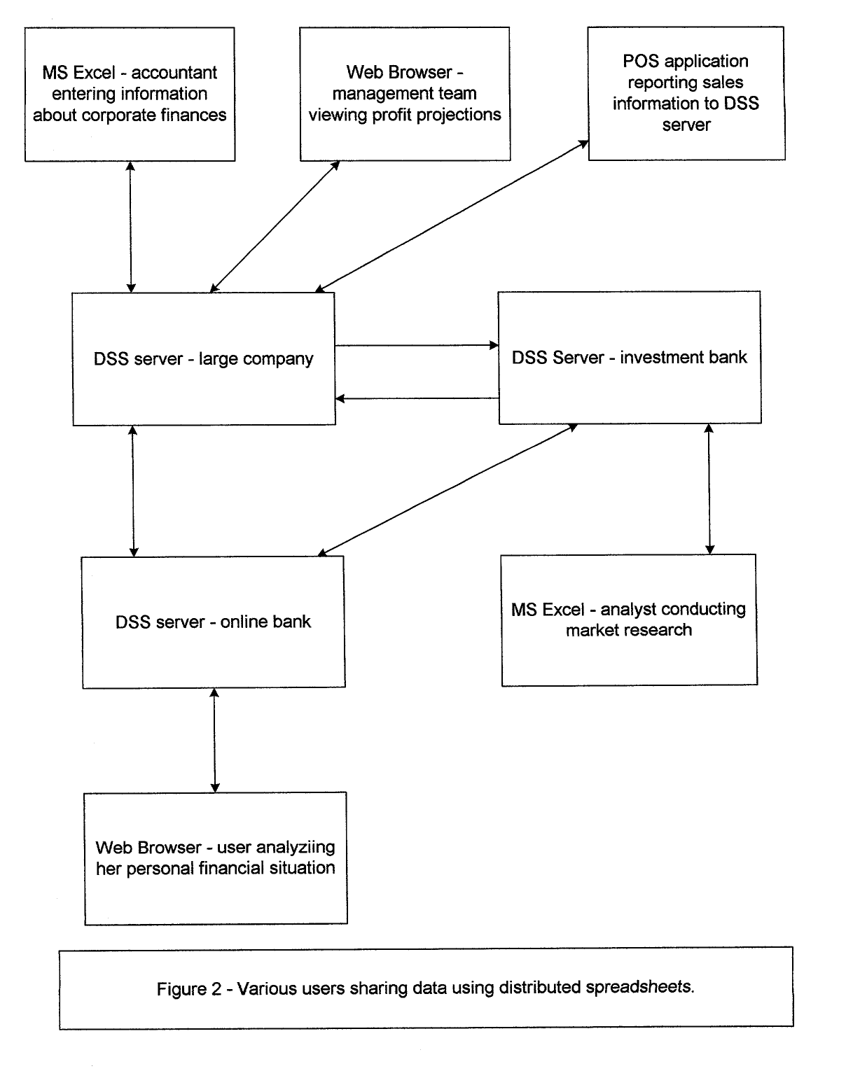

FIG. 3: this diagram illustrates the technique of integration by adapter. The goal here is to allow a legacy third party application to share its data with DSS-enabled applications. This is done by creating an adapter, which adheres to a specific interface, and communicates with the third party application to obtain desired spreadsheet information. The DSS frontend takes data from the adapter and serves it to the world. The key here is only the adapter needs to be rewritten for each third party application; the frontend is generic and can be reused.

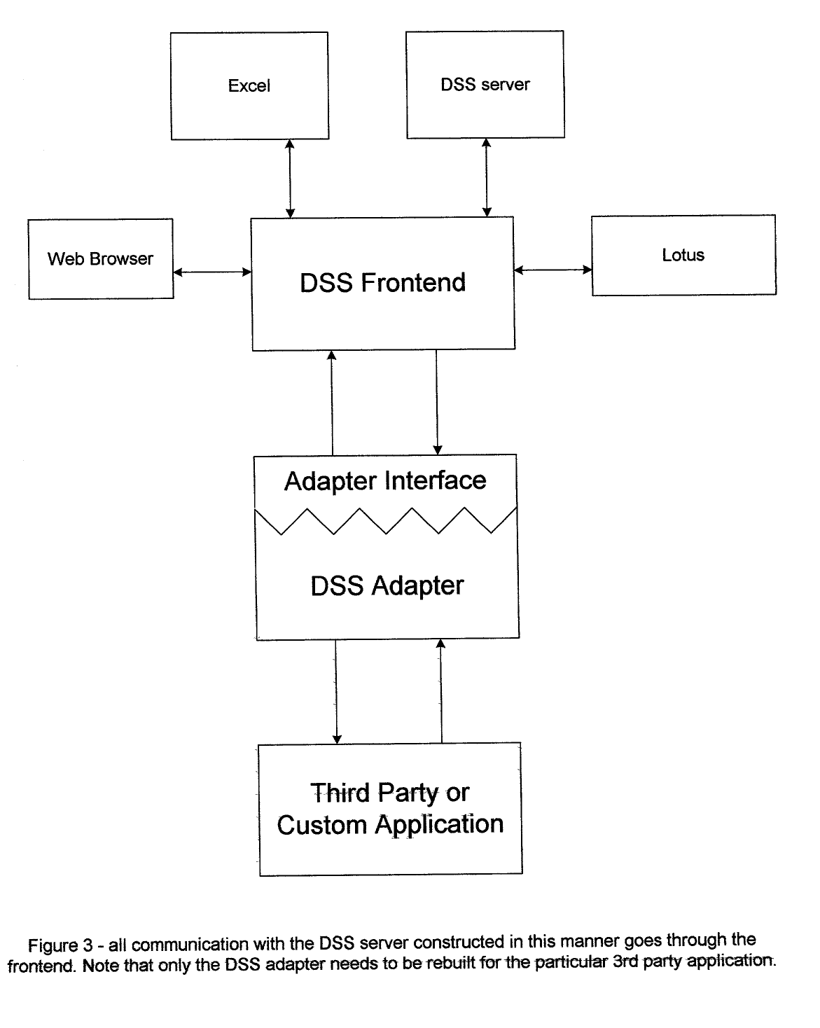

FIG. 4: This diagram illustrates the technique of integration by report. Here, the third party application is modified to send DSS commands to the DSS server to report on whatever events need to be recorded. For example, if the third party application is a point of sale tool, then it will send reports to the DSS server describing sales that have been made. The DSS server keeps track of the information in a spreadsheet, and therefore can provide the data to whatever client applications request it.

### DETAILED DESCRIPTION OF THE PREFERRED EMBODIMENT

1. Overview

The nature of the present invention resists an attempt to describe each and every aspect of its functioning. The reason for this is twofold: 1) because the DSS structure involves a multitude of different systems working in concert and 2) because the central piece of software, the DSS server, is in its full embodiment extremely complex and uses a large amount of technology which is accepted as standard but would require volumes to describe in detail. Therefore, this section covers only the central ideas of the invention, in particular those concepts which are enumerated in the ‘claims’ section.

The following description will focus primarily on the preferred embodiment of DSS technology as implemented in a web-centric paradigm, ie, using a web browser as the primary means of interacting with the DSS server, and using HTTP (the protocol used by web servers to distribute web pages) as the method of communication. However, the present invention could be implemented in a variety of ways and using a variety of protocols to transmit data.

Part 2) of this section describes the workings of the DSS server. This software system is at the center of the DSS system. It is responsible for hosting and serving DSS objects.

Part 3) describes DSSP, the protocol used by DSS applications to communicate.

Part 4) describes two techniques which will allow organizations to integrate third party software applications with the DSS structure.

Part 5) discusses a solution to a central problem of DSS technology, recalculation overload.

2. DSS Server

A DSS server is a computer program that hosts, serves, and performs calculations on distributed spreadsheets. Distributed spreadsheets resident on a DSS server are called DSS objects. DSS objects, or certain cells of DSS objects, can be made public, thereby allowing other users to refer to the data they contain.

This description covers only the fundamental aspects of the DSS server's functionality and architecture. It is expected that those skilled in the art will understand the description and will be able to develop or construct the system given these guidelines.

2a. Basic Architecture

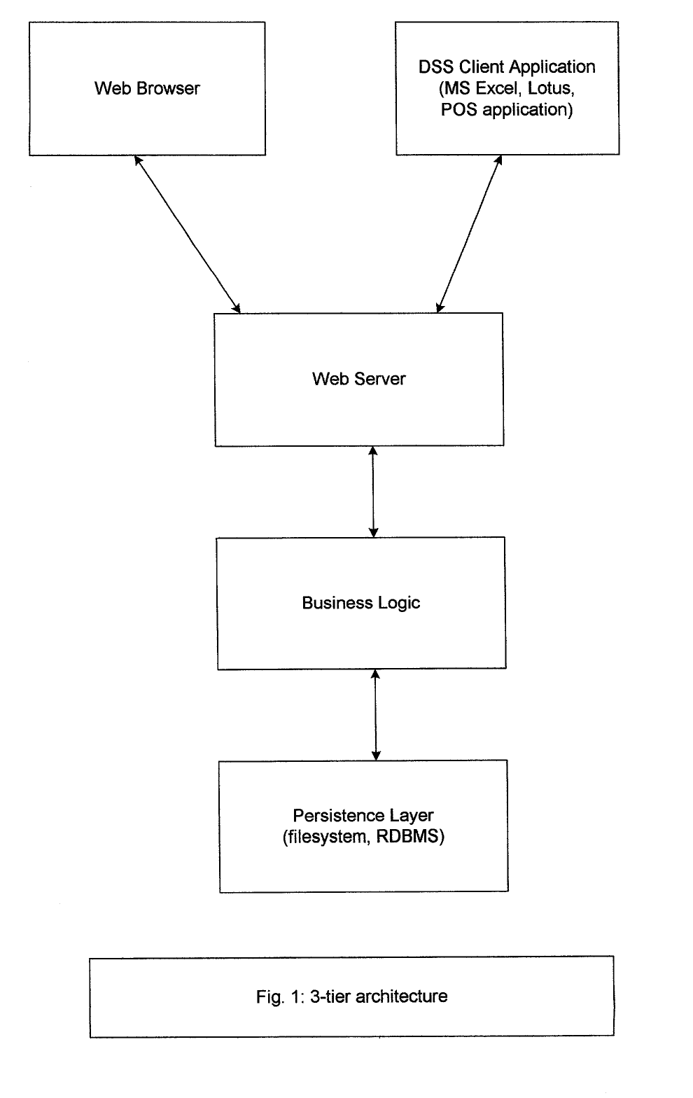

The general components of the system are displayed in FIG. 1, “3-tier architecture”. The lower three levels (persistence layer, business logic, and web server) compose the DSS server application while the other two components (web browser, client application) are external programs which interact with the DSS server.

1. Persistence Layer. This is where the application stores the data that represents the spreadsheets. In many web applications, a relational database (RDBMS) is used for this purpose. Alternately, the spreadsheets could be stored as simple files, preferably in an XML format. The business logic interacts with the persistence layer to bring the spreadsheet data into memory when it is needed.

2. Business Logic. This is where the core logic for the system resides. This system is responsible for a variety of things. Of particular importance are:

a. Spreadsheet lookup—the component which finds the particular DSS object referred to by a request;

b. Calculation engine—the component which recalculates the derived values in DSS objects when necessary;

c. Spreadsheet peer—the component responsible for communicating with the persistence layer to maintain spreadsheet data and to ensure that the data is consistent;

d. Remote command interface—the component which allows remote commands to be executed on the DSS server by client programs;

e. Security Control—the component which provides user authentication, encryption, and access control for system security.

See below for a more complete description of these components.

3. Web Server. This component connects the system to the outside world. A variety of web servers exist today, such as Apache and Microsoft Internet Information Server. The web server connects to the business logic and passes the information sent to it from various clients. Additionally, the web server handles tasks such as threading and connection pooling. In the preferred embodiment, the DSS server uses the web server component for all communication with the outside world, because web server technologies have been engineered to a high degree of efficiency.

4. Web Browser. In the preferred embodiment, one of the main ways in which users and system administrators interact with the system is through a web interface. A web interface uses standard HTML pages to present a way for users to get information and invoke commands on the DSS server. Typical tasks might include creating/deleting users or spreadsheets. Users will also have the ability to view and edit spreadsheet information through the web, but the preferred way to edit a DSS object is by downloading it to a desktop spreadsheet, making the changes, and uploading it again.

5. Client Application. This is where the usefulness of the system becomes evident. Client applications, including particularly but not limited to spreadsheet programs such as Microsoft Excel or Lotus 1-2-3, will be able to make references or links to spreadsheet data hosted on the DSS server. Therefore, when the referred-to data changes, the users' spreadsheets will be automatically updated, without requiring the user to do any work whatsoever. Note that DSS servers will often act as clients to other DSS servers, when they host DSS objects that contain references to external data.

2b. Business Logic

1. Spreadsheet lookup. In the preferred embodiment, the DSS objects on the DSS server have unique paths associated with them, such as ‘/accounts/texco/january’. This path specifies that the spreadsheet is named ‘january’ and is located in folder ‘texco’, which in turn is located in folder ‘accounts’. This system is similar to that used for normal hierarchical filesystems. This provides a reasonable amount of flexibility while making sure that the location of a spreadsheet uniquely identifies it. The spreadsheet lookup component is responsible for finding the desired DSS object given the path and sheet name.

2. Calculation engine. One idea that is particularly important to the concept of distributed spreadsheets is that the DSS server never serves a formula or reference, only a value. Therefore, it is necessary for the DSS server to be able to run spreadsheet calculations itself, and make those calculations before serving values. In the preferred embodiment, the DSS server uses a third party component to make spreadsheet calculations, such as Microsoft Excel or Formula One for Java (from Tidestone Technology). However, these software systems must be extended to enable them to understand the use of DSS cell references in the spreadsheets.

3. Spreadsheet peer. When the spreadsheet lookup subsystem finds the DSS object needed by a particular request, it invokes the spreadsheet peer to read the object from the persistence layer. This requires a significant amount of logic. Two possible methods of persisting DSS objects are XML files on a filesystem or a group of tables in a relational database. If the former, the spreadsheet peer needs to know how to read and parse the XML files and to convert them into in-memory objects. If the latter, the spreadsheet peer needs to know how to execute the appropriate SQL queries to convert the data in the tables into an in-memory representation of the spreadsheet. Moreover, the peer must use appropriate synchronization techniques to ensure data is not modified concurrently by multiple client applications, and must make data commitments at appropriate times to ensure transactional integrity.

4. Remote command interface. The DSS server exposes a significant amount of functionality to external client applications. The primary goal of permitting these remote commands is to enable third party applications to share their data with the DSS structure by reporting when they collect data. Therefore, the most important operations permitted by the remote command interface is adding, modifying, or deleting DSS objects and cells. See section 3b) for a description of how these remote commands work.

5. Security. Security is the hobgoblin of modern internet computing and DSS use is no exception. There are many levels of control that must be thought about for the creation of this system. Essentially they can be separated into three basic topics:

a. Encryption. Communication between DSS servers and clients must be encrypted to prevent unauthorized users from observing the flow of data between applications. Standard techniques should suffice for this requirement, in particular SSL (Secure Socket Layer) which is a standard component of most modern web servers and browsers.

b. Permissioning. The system must be able to determine whether or not a particular user has the ability to perform a given operation on a DSS object. There are a myriad of permissioning idioms in use today and it is the author's belief that none are perfect, but that the most important requirement is to make sure that the system is easy to understand. Therefore, the preferred embodiment minimics the permissioning standard used by the Unix filesystem. Each DSS object will have a 3-digit number corresponding to the permissions that are granted to owner, group, and world. Typically, owner will have equal or greater permissions than group, while group will have equal or greater permissions than world. The system determines which access category to describe the user as by first checking if the user is the owner, then checking if the user is a member of any groups associated with the DSS object, and if neither of the first two categories fits than assigning world permissions. In the Unix system, each permission category is allowed read, write, or execute permissions, or some combination of these. In DSS setting, read permissions will allow the user to read data from the DSS object. Write permissions will allow the user to edit data in DSS cells. Execute permissions will allow all other operations, such as deleting the DSS object, adding groups to the permission list, and changing the name of the spreadsheet or moving it. When the DSS object is created, the creator has full permissions and the other categories have no permissions. Finally, a set of administrators will be granted full permissions to all DSS objects in the system.

c. User authentication. Users will be granted user names and passwords. The passwords will be encrypted using a one-way encryption technique similar to that used in the Unix operating system. When the user attempts to log in, the password checking logic uses the same algorithm to encrypt the string the user enters, and checks to see if the output is the same as the string in the password table. If so, it allows the user to log in. The benefit of this method is that because of the one-way encryption even the system administrators cannot read users' passwords. Once the user's identity is confirmed, the application that the user is logging in from is sent a validation token which the DSS server requires for subsequent requests. See section 3c) for a description of how these validation tokens work.

2c. Data Format Translation

One important additional function that the preferred embodiment of the DSS server provides is that of data format translation. This essentially means that the DSS server has the capability to take the data file representation of a desktop spreadsheet and transform it into a DSS object and store it. For example, a user will be able to upload a Microsoft Excel spreadsheet file and the DSS server will be able to parse it to derive the information relating to values, formulae, and references present in the spreadsheet and save it in the persistence layer, whether that is an XML file or a database representation. The preferred method for users to create new DSS objects is for them to begin entering data in a desktop spreadsheet application, and then upload the file to the DSS server.

Additionally, the DSS server will be able to generate spreadsheet data files that represent DSS objects it contains. Users will be able to download spreadsheets from the DSS server, make changes to them with a desktop spreadsheet program, and upload them again to the DSS server, thereby making the changes known to the public. Finally, users will be able to employ the DSS server to translate data between formats, by uploading the data in one format, and downloading it in another.

2d. Method to Prevent Recalculation Overload

One particularly pressing problem with the creation of distributed spreadsheets is that of recalculation overload.

Consider what happens when a request arrives for the value in a particular cell. Imagine that the cell itself is a derived value, and the derivation relies on other cells which contain references to data across the internet. Therefore, in the most naive implementation, requesting this derived cell will cause the DSS server to make requests of other DSS servers, and the chain of recalculation and re-request could continue on without end.

To understand how this problem can come about in the real world, imagine two companies, company A and B. Each company holds an amount of stock in the other. Therefore, the value of each company, and in turn its stock price, is recursively dependent on the value of the other company. Thus to evaluate either company's worth in a DSS setting would require an infinite sequence of recalculations.

The solution to this problem is for the DSS server to maintain two sets of data, one public and the other private. The public data is generated by evaluating all cells in the private data and creating copies of the private spreadsheets which contain only the derived values, and not the derivations themselves. When a request arrives, only the public data is served. The public data is calculated and refreshed at periodic intervals, but never as a result of a request. Therefore, remote requests never cause spreadsheet recalculation.

The somewhat unfortunate downside to this solution is that data is never really perfectly up-to-date; there is always the possibility that some event has occurred which has not yet percolated through the chain of DSS recalculations. Nevertheless we believe that this is an acceptable solution to the problem.

3. DSS Protocol—DSSP

It is expected that DSS applications will be implemented by a plurality of vendors and software companies. This means that it is necessary to create a protocol to allow smooth interaction between various DSS applications.

This protocol is called DSSP—distributed spreadsheet protocol—and encompasses a variety of purposes. In general, all communication relating to DSS comes under the heading of DSSP. The two main categories of DSSP are queries and commands.

DSSP is built upon existing protocols such as XML, HTTP, and TCP/IP.

3a. DSS Queries and Query Responses

The DSS query is the central feature allowing the creation of distributed spreadsheets. A DSS query occurs when a spreadsheet application finds that one of the cells in the spreadsheet it is evaluating contains a reference to a cell located on the internet. The application then makes a DSS query to retrieve the value for that cell.

In the preferred embodiment, basic queries are carried out in the following manner. The reference formula in the given cell contains an HTTP URL which is similar to the following:

http://dss.bigcompany.com/dssquery?folder0=profit&folder1=may&sheetname=newyork &rowid=5&colid=2

In this case, the DNS name of the remote DSS server is ‘dss.bigcompany.com’. The string ‘dssquery’ is the standard invocation path for DSS queries. The query string (the information after the question mark) contains the folder path (‘/profit/may’), the name of the DSS object (‘newyork’), and the row and column ID of the desired cell (5, 2).

The DSS client application then requests the resource at the given location using standard HTTP. The DSS server receives this request and creates an XML file describing the desired data. This XML file must adhere to a specific format. Please see Appendix A for an example of a DSS query response.

Once the spreadsheet application receives the response, it parses the XML to retrieve the desired data and inserts that data into the spreadsheet.

Note that this technique can be used by applications other than desktop spreadsheet applications. In fact, any program that can connect to the web via HTTP and can parse XML can use data hosted by a DSS server.

3b. DSS Commands and Command Responses

In addition to basic DSS queries, DSSP specifies a means by which DSS client programs can invoke remote commands on a DSS server. The structure of the communication governing these interactions is similar to that of DSS queries, but somewhat more complex.

There are many possibilities for DSS commands, including but not limited to adding or deleting user accounts; adding, editing, or deleting cells in a DSS object; and creating or deleting DSS objects themselves.

When the DSS client application decides to perform a remote operation, it first creates an XML file identifying the command it would like to invoke and describing the arguments for that command. For example, if the operation is to add a cell to a given row in a given DSS object, then the XML file would specify the value of the cell to be added, the row to add it to, and the ID (folder list and sheet name) of the DSS object. Then it would create an HTTP URL based on the DNS name of the DSS server:

http://dss.bigcompany.com/dsscommand

Again, the string ‘dss.bigcompany.com’ is the DNS name of the DSS server and the string ‘dsscommand’ is the standard prefix for invoking DSS commands.

The DSS client application uses standard HTTP to upload the XML file to this location. The DSS server receives the file, parses it, and performs whatever operation is specified. Finally, the DSS server creates another XML file called a command response and sends this file back to the DSS client. The command response file describes the results of the operation—whether it succeeded or failed, and if it failed an error code denoting the reason for the failure.

The format of the XML command files are regulated by DSSP, as is the format for the command response files, and the meaning of the error codes. Please see Appendix A for examples of a DSS command and command response.

3c. Security

Because DSSP builds on other protocols, in particular HTTP, it is able to make use of the security features built into HTTP.

There are two basic security modes, low and high. In both modes the user logs in to the DSS server through a secure HTTPS connection. If the username/password pair supplied are correct, the system sends the client application, also through HTTPS, a validation token. This token is based on the user who has logged in, and the IP address of the machine from which the login request has arrived, and is created using an encryption key specific to the DSS server. The token is stored in the client application as an HTTP cookie.

After the user has logged in, the client application can perform whatever queries or commands desired. The DSS server uses the validation token to verify that the user is legitimate, and then checks that the user has sufficient permissions to perform whatever task he or she is attempting to invoke.

In the high-security mode, all communications between DSS servers and client applications are encrypted using SSL. In low-security mode, communication that takes place after the login is not encrypted, meaning that observers who have the ability to eavesdrop on the transmissions will be able to observe the DSS data. However, the validation token is keyed to the IP address of the original login, therefore preventing hackers from using it to invoke their own commands on the DSS server by copying the validation token.

4. Integration

It will be useful to companies and organizations to integrate their financial and numerical data applications with the DSS system. This will allow them to share data between disparate applications; in particular, allowing them to access and view data generated by third party or custom applications which are already deployed. There are two basic techniques with which organizations can accomplish this goal.

4a. Server Integration by Report (Push)

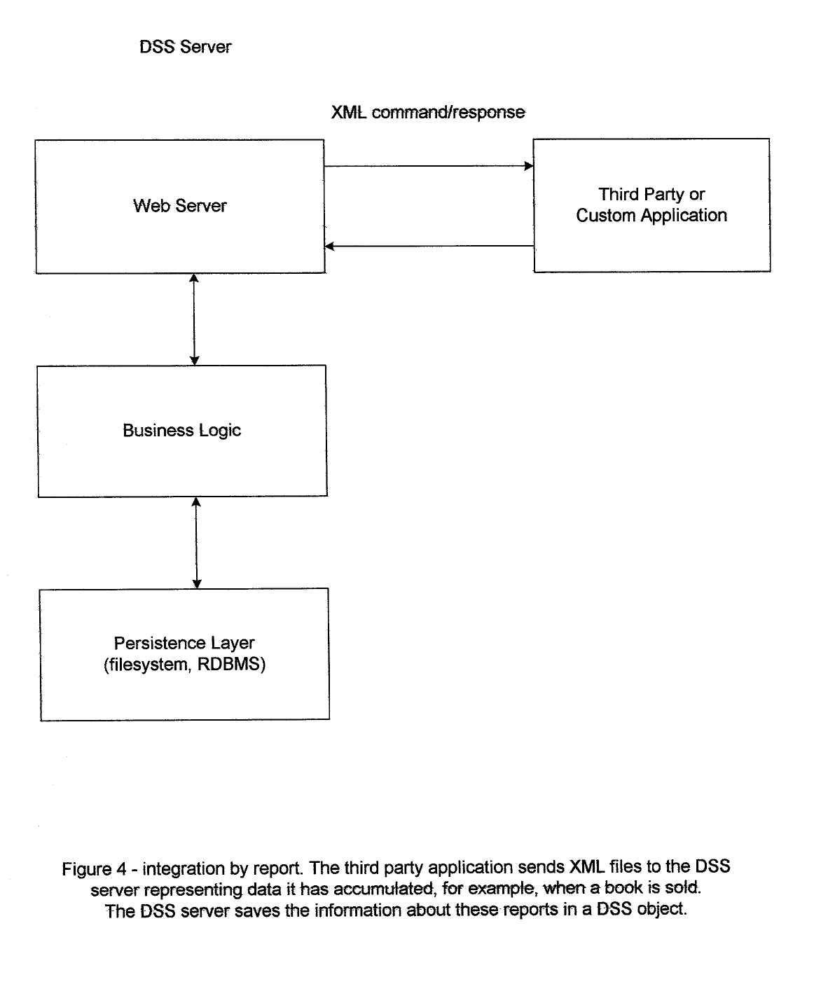

This technique involves modifying third party applications to report interesting data to the DSS server, which stores the information in a spreadsheet. These reports are a form of command operation as described in section 3b). They are created when specific events occur, for example when a sale is made. Once the data is reported to the DSS server, it can be shared with other DSS applications. The interaction between a third party application and a DSS server is illustrated in FIG. 4. This is a form of ‘push’technology.

Consider the following example.

A book selling company has a point-of-sale (POS) application installed at all of their store locations. This application stores data about things like the number of books being sold and the current inventory.

The company wishes to use DSS technology to obtain an always up-to-date view of the number of book sales the stores are making. This is done by creating a spreadsheet on the DSS server to hold the sales information, and modifying the POS application to send reports to the DSS server whenever a sale is made. This is done using DSS commands as described in section 3b). The command tells the DSS server to add a cell or cells to the spreadsheet, and contains relevant information such as the ID of the spreadsheet, the row to add the cells to, and the value to insert. The spreadsheet is then gradually built up to contain all relevant information about sales that are being made, and it is trivial to derive interesting data regarding total revenues, number of sales, and so on.

Once the system of reporting is implemented at the level of the POS application, the entire DSS structure has access to the information from the book stores. Everyone who has permission to access the relevant distributed spreadsheet can use that information in their own spreadsheets, calculating revenues, profit levels, etc.

4b. Server Integration by Adapter (Pull)

This integration technique works by creating a DSS adapter that translates information kept in the third party application into DSS objects. This is an example of ‘pull’technology because the data is translated upon request.

To do this is conceptually straightforward. There are three pieces of software involved. One is called the DSS server frontend. This is responsible for many of the generic operations of the DSS system, such as accepting requests and formatting responses.

The second piece of software is called the DSS adapter. The DSS adapter is designed specifically for a given third party system. It implements a certain interface that is required for DSS. The interface requires it to perform some basic operations. One such operation is that, given a locator string or ID for a spreadsheet, the DSS adapter must query the third party system and return the spreadsheet object corresponding to that ID. Other operations might include creating new spreadsheets, deleting spreadsheets, and modifying data in the spreadsheets. The designer of the adapter must decide what reasonable behavior is for all of these operations—in some cases, normal DSS operations might not make sense or cannot be allowed when using another application as a data source.

The last piece of software is the third party system itself The interaction between the three pieces is shown in FIG. 4b.

The important thing to note about this configuration is that the DSS frontend, which comprises much of the complexity of the system, does not have to be rebuilt for each third party application. This is because it uses only methods which are specified by the adapter interface. The DSS adapter handles all of the work of translating the data in the third party application into DSS-ready information.

Consider the following example. A large company has an employee database that has table entries denoting each of the employees' salary. One important number in any financial overview of the company would be the amount of money that is spent on payroll. Using DSS integration by adapter, the company could set up a DSS server which hosts a spreadsheet which pulls information from the employee database on demand. Accountants could then link to this spreadsheet to generate cash flow and profit reports. Because the spreadsheet is linked to data in the employee database, it will change when the employee data changes, and therefore the accountants will always have the most up-to-date information.

5. DSS Cell Reference Implementation

In order for desktop spreadsheet applications to understand how to interpret DSS cell references, they must be extended in a particular way. Most modern desktop spreadsheet applications provide an interface for users to create new functions in addition to those already defined by the application. This allows us to easily create code to interpret DSS cell references and take the appropriate actions when one is encountered.

The implementation of this system is straightforward. The user enters a DSS formula which looks something like this:

=dss(“http://dss.bigcompany.com/dssquery?folder0=profit&folder1=may&sheetname=ne wyork&rowid=5&colid=2”)

The spreadsheet application recognizes that this indicates a DSS query, downloads the XML file located at the given URL, and parses the XML to find the appropriate value and inserts it into the cell.

If the user has not logged in to the DSS server yet, then he or she will be required to do so before the DSS request is completed. See section 3c) for a description of security measures used in DSS applications.

Glossary of Terms

Cell—an individual piece of data in a spreadsheet. A cell may contain a value, such as “12.3”; a formula, such as “=sum(a1:a3)”; or a reference to a cell in another spreadsheet (see below).

Cell reference—a reference to a cell in another spreadsheet. In Microsoft Excel for example, a cell reference looks like this: =quarter1:b2. The string ‘quarter1’ is the name of the spreadsheet, the string ‘b2’ is the ID of the cell within that spreadsheet.

DSS—distributed spreadsheet. A spreadsheet which contains references to data sources exterior to the file or application that the spreadsheet is associated with, in particular, sources which are found by going across the internet.

DSS application—a DSS server or a client application that interacts in some way with a DSS server or servers.

DSS cell reference—a cell reference that points to a cell in a DSS object on a DSS server. The syntax of the cell reference is dependent on the spreadsheet application, but the cell reference will always contain a specially formatted HTTP URL.

DSS client—an application that requests data from a DSS server. An example is a desktop spreadsheet application that requests DSS information to use in the spreadsheet that it is running. Note that DSS servers often also act as DSS clients, because they may host DSS objects which contain references to information on other servers.

DSS command—an operation invoked by a client application on the DSS server, which is done by sending the DSS server an XML file containing the information required for the command. Possible commands include but are not limited to: adding or deleting DSS objects, adding, editing, or deleting cells, or adding or deleting users of the DSS server.

DSS command response—an XML file created by the DSS server that indicates the results of a DSS command.

DSS object—a spreadsheet that is hosted by a DSS server.

DSSP—distributed spreadsheet protocol. A collection of formatting rules, interfaces, and subprotocols that allow disparate DSS servers and client applications to communicate. In its preferred embodiment, DSSP is built on top of other protocols such as TCP/IP and HTTP to take care of lower-level communication between programs.

DSS query—a request sent to a DSS server for spreadsheet data. In the preferred embodiment, the query is made by making a request to a particular URL, where information in the query string of the URL indicates which DSS object is referred to. Typically the query is for the value of a particular cell in a particular spreadsheet.

DSS query response—an XML file sent by a DSS server as a response to a DSS query. The XML file contains the cell data requested, or an error message indicating why the query failed.

DSS server—a computer system which hosts, serves, and allows creation, modification, and deletion of DSS objects, as well as various other administrative functions. The DSS server interacts with other programs through the DSSP protocol.

DSS structure—a web or network of interconnected spreadsheet information, potentially comprising many DSS servers and various DSS client applications. Once a piece of data is available to part of the DSS structure, any other part can access it, assuming that the user has appropriate permissions.

Spreadsheet—a collection of data and derivation rules. Please see “Background” section for a discussion of the history and usage of spreadsheets.

Spreadsheet application—a program which allows users to create, modify, and view spreadsheets. Examples are Microsoft Excel and Lotus 1-2-3.

References and Web Links

1. Spreadsheet Applications

Microsoft Excel:

http://www.microsoft.com/office/excel

Excel 2000 Programming with VBA, by John Walkenbach

Microsoft Excel 2000 Visual Basic for Applications: Fundamentals, by Reed Jacobson

Formula One for Java

http://www.tidestone.com/

Lotus 1-2-3

http://www.lotus.com/home.nsf/welcome/123

2. XML

http://www.xml.org

http://www.w3 schools.com/xml/

The XML Handbook, 3^{rd} Edition, by Charles F. Goldfarb and Paul Prescod

Essential XML: Beyond Markup, by Don Box et al.

3. HTTP and Web Programming

Core Web Programming, by Marty Hall and Larry Brown

HTTP Essentials: Protocols for Secure, Scaleable Web Sites, by Stephen Thomas

Apache: The Definitive Guide, by Ben Thomas, Peter Laurie, and Robert Denn (ed.)

Microsoft Internet Information Server Resource Kit, by Microsoft Corp.

http://www.caucho.com/(web site describing Resin, a Java servlet engine)

4. Unix Topics

http://www.perlfect.com/articles/chmod.shtml(discussion of Unix permissioning system)

http://www.rt.com/man/crypt.3.html(description of Unix crypt program)

Appendix A - DSSP examples

```
1. DSS Query Response
<response>
  <sheet path = “/expenses” name = “january”>
    <cell row = “5” col = “a”>13.2</cell>
  </sheet>
</response>
In this example, the relevant value is 13.2 The XML file contains additional
information, such as the path and name of the spreadsheet, and the row and
column of the desired cell. This is to allow the client application to verify
that the response it received is valid.
It is possible to imagine extending the query mechanism to allow clients to
access groups of cells in one request. In that case, the cell information would
simply be listed as multiple ‘cell’ child elements of the ‘sheet’ group, as
follows:
<response>
  <sheet path = “/expenses” name = “january”>
    <cell row = “5” col = “a”>13.2</cell>
    <cell row = “6” col = “a”>14.5</cell>
    <cell row = “7” col = “a”>15.6</cell>
  </sheet>
</response>
2. DSS Command
<command code = “addcell”>
  <sheet path = “/expenses” name = “january”>
    <cell col = “c” value = “14.5”/>
  </sheet>
</command>
In this example, a client application has sent a message to the DSS server
indicating that it desires to add a cell to a given spreadsheet. The spreadsheet
name and path is given, as well as the value of the cell to add - 14.5.
Additionally, the column to add the cell to is specified. In this case the cell
will be added to the row after the last non-null cell in column ‘c’.
<command code = “adduser”>
  <user name = “burfoot” password = “zodan123”/>
</command>
This DSS command instructs the DSS server to add the user “burfoot” with
password “zodan123”. Note that this transmission will be secured through use of
SSL.
3. DSS Command Response
<commandresponse code = “success”/>
This simple command response indicates that the command issued by the DSS client
was successful.
<commandresponse code = “failure”/>
  <error code = “4”>The user name ‘burfoot’ is already in use.</error>
</commandresponse>
This command response designates failure, gives an error code (4), and a
description of the reason for the failure of the command.
```

I claim:

1. A computer program, called a DSS server, that performs the following tasks:
a) Maintains data representing spreadsheets in a persistence layer, such as a filesystem or database;
b) Allows users to create, delete, and modify said spreadsheets, including especially the values and derivation formulae of the spreadsheet cells;
c) Serves the derived values of said spreadsheet cells to client applications upon valid request;
d) Runs calculations when necessary to derive the values of said spreadsheet cells;
e) Performs various ancillary functions relating to the above tasks, such as maintaining user information, encrypting data when desired, caching data to speed performance, enforcing an access control policy, and providing an interface for system administration and basic data access.
(see Detailed Description section 2).

2. A method of creating a software system that implements some subset of the functionality of the DSS server as described in claim 1) while using data contained in another application as a source for spreadsheet data, by using a generic DSS frontend to communicate with client programs and an adapter built specifically to connect the frontend and the other application (see Detailed Description section 4a).

3. A protocol for controlling communication between DSS servers and DSS client applications, allowing such programs implemented by different vendors to work together seamlessly, which comprises:
a) a format for DSS queries and DSS query responses, used for the communication of spreadsheet data, wherein the client program constructs the query and the server replies with the query response;
b) a format for DSS commands and DSS command responses, allowing client programs to interact in various ways with the DSS server, such as creating or deleting spreadsheets, adding or editing cell values, adding or deleting users, and other operations;
c) techniques to use to ensure the security of these communications.
(see Detailed Description section 3).

4. A method for accessing data resident on a DSS server or similar program as stated in claims 1-2), in a client application such as a desktop spreadsheet application, using the protocol described in claim 3) (see Detailed Description section 3a).

5. A method for sending various commands to a DSS server or similar program as described in claims 1-2), to perform operations such as creating or deleting spreadsheets, adding, editing or removing cells in a spreadsheet, adding or deleting users of the DSS server, and various other operations, from a client application, using the protocol described in claim 3) (see Detailed Description section 3b).

6. A method for creating DSS cell reference formulae in spreadsheet applications to cell data served by computer programs listed in claims 1-2) above, and using the method of data access as described in claim 4) (see Detailed Description section 5).

7. A method of integrating a third party application with a DSS server by modifying the application to report to the DSS server when certain events occur, such as sales, using the protocol described in claim 3), thereby allowing the DSS server to keep track of the reported information in a spreadsheet, and to share that information to DSS client applications (see Detailed Description section 4b).

8. A method for preventing recalculation overload in the DSS server by keeping two distinct sets of spreadsheet data, one public and one private, where the former is updated from the latter at set intervals and otherwise does not change (see Detailed Description section 2d).
